(19) United States
(12) Patent Application Publication
(10) Pub. No.: US 2024/0396065 A1
(43) Pub. Date: Nov. 28, 2024

(54) Fuel Cell System and Electric Vehicle

(71) Applicant: Max Eschenbach, München (DE)

(72) Inventor: Max Eschenbach, München (DE)

(73) Assignee: GLOBE Fuel Cell Systems GmbH, Stuttgart (DE)

(21) Appl. No.: 18/667,391

(22) Filed: May 17, 2024

(30) Foreign Application Priority Data
May 25, 2023 (DE) 10 2023 204 915.5

(51) Int. Cl. H01M 8/04701; H01M 8/0239; H01M 8/04014; H01M 8/04029; H01M 8/04119; H01M 8/04746; H01M 8/2475

(52) U.S. Cl. CPC H01M 8/04723; H01M 8/0239; H01M 8/04014; H01M 8/04029; H01M 8/04156; H01M 8/04761; H01M 8/04768; H01M 8/2475; H01M 2250/20

(57) ABSTRACT

A fuel cell system includes a housing enclosing an inner housing space. Housing sides delimit the inner housing space permeable to air. A fuel cell stack is in the housing interior having plurality of fuel cells. There is a cooling circuit cooling the fuel cell stack in which a liquid coolant circulates. A heat exchanger is integrated into the cooling circuit cooling the coolant and through which air flows. A fan is in the housing interior driving the air flow. A favourable dilution of exhaust gas from the fuel cells is achieved with an exhaust gas line guiding the exhaust gas from the fuel cells to the suction side of the fan. The air flows during operation of the fan from an environment of the housing into the housing interior and flows in the housing interior through the heat exchanger and from the housing interior back into the environment.

### CROSS-REFERENCE TO RELATED PATENT APPLICATIONS

This patent application claims priority to German Application No. 10 2023 204 915.5, filed May 25, 2023, the entire teachings and disclosures of which are incorporated herein by reference thereto.

### FIELD OF THE INVENTION

The present invention relates to a fuel cell system and an electric vehicle equipped therewith, such as an intralogistics vehicle.

### BACKGROUND OF THE INVENTION

Fuel cell systems are generally known and have at least one fuel cell stack comprising several fuel cells. Within the respective fuel cell, a membrane or electrolyte separates an anode side from a cathode side. During operation of the fuel cell system, cathode gas is supplied to the respective cathode side, usually air from an environment of the fuel cell system. At the same time, cathode exhaust gas is discharged from the cathode side. The respective anode side is supplied with anode gas, which is hydrogen, for example, while anode exhaust gas is discharged from the anode side and may contain a comparatively large amount of water that forms on the membrane during the fuel cell process or is condensed there. While the cathode gas is expediently supplied and discharged continuously, the anode gas is expediently supplied and discharged intermittently or cyclically, which supports the efficiency of the fuel cell process by discharging diffusing nitrogen through the membrane and ensuring a sufficient hydrogen concentration. As a rule, the anode exhaust gas still contains a comparatively large amount of residual hydrogen, so that it is common practice to feed the anode exhaust gas back into the anode gas. In other words, anode gas recirculation is carried out. However, there are also operating states in which anode exhaust gas must be released into the environment, e.g. to flush the anode side. Here, of course, minimal or no hydrogen should be discharged into the environment. Nevertheless, the anode exhaust gas may still contain residual hydrogen depending on the actual boundary conditions. When emitting anode exhaust gas into the environment, care must be taken to ensure that no ignitable mixture, so-called oxyhydrogen gas, is produced. Accordingly, a predetermined maximum concentration of hydrogen in the environment of the fuel cell system must not be exceeded. This is usually not a problem with fuel cell systems that are used outdoors, provided there are no ignition sources in the vicinity of the fuel cell system. For fuel cell systems that are used in buildings or other enclosed spaces, however, greater care must be taken to avoid an increased hydrogen concentration.

Electric vehicles have an electric motor drive and can be equipped with a fuel cell system to provide the electrical energy. This applies in particular to intralogistics vehicles such as forklift trucks, industrial trucks and transport vehicles, with self-propelled vehicles becoming increasingly important.

### SUMMARY OF THE INVENTION

The present invention deals with the problem of providing an improved or at least another embodiment for a fuel cell system which is characterised by a reduced concentration of hydrogen in the environment of the fuel cell system.

A fuel cell system is known from CN 2 796 110 Y, in which an exhaust gas line leads the exhaust gas from the fuel cell to a fan, which, during operation of the fuel cell system, ensures that the exhaust gas from the fuel cells is sucked in and fed directly into the environment.

Similar fuel cell systems are also known from CN 2 796 121 Y, CN 106 299 408 B and JP 4 986 607 B2.

The problem underlying the invention is solved by the subject matter of the independent claim. Advantageous embodiments are the subject of the dependent claims.

The invention is based on the general idea of utilising an air flow that is already present in the fuel cell system for cooling purposes to dilute the exhaust gas of the fuel cells, so that the critical hydrogen concentration in the environment can be avoided.

Specifically, the fuel cell system is equipped with a cooling circuit for cooling the fuel cell stack, in which a liquid and usually deionised coolant circulates. A heat exchanger is integrated into this cooling circuit, is used to cool the coolant and can be passed through by an air flow. To generate or drive the air flow, the fuel cell system is equipped with a fan, which can be arranged upstream or downstream of the heat exchanger with respect to the air flow and which has a suction side and a pressure side. An exhaust gas line, which guides the exhaust gas from the fuel cells, is now configured in such a way that it guides the exhaust gas to the suction side of the fan. In this way, the exhaust gas in the fan is mixed with the air flow that passes through the heat exchanger to cool the coolant. This greatly reduces any increased concentration of hydrogen contained in the exhaust gas.

In the present context, a “configuration” is synonymous with a “design”, so that the phrase “configured in such a way that” is synonymous with the phrase “designed in such a way that”.

When the fan is in operation, the air flow flows from the environment of a housing of the fuel cell system into a housing interior enclosed by the housing and flows in the housing interior through the heat exchanger and out of the housing interior back into the environment. The intensive mixing of the exhaust gases with the air flow prevents an unacceptably high concentration of hydrogen in the vicinity of the housing.

According to an advantageous embodiment, the fan can be arranged upstream of the heat exchanger with respect to the air flow in such a way that the suction side of the fan faces the interior of the housing, while the pressure side of the fan faces the heat exchanger. This means that the fan pushes or displaces the air flow through the heat exchanger, which is advantageous in several respects. The heat exchanger forms an obstacle to the flow of air. The forced flow through the heat exchanger supports intensive mixing of the exhaust gas with the air flow. Furthermore, the exhaust gas from the fuel cells may contain water vapour, which may condense on the fan. Water droplets that form in the process can then be atomised on the rotating blades of the fan. The fine water droplets reach the heat exchanger with the air flow and can wet the structure of the heat exchanger there. The very large surface area of the water droplets then comes into contact with the large surface area of the heat exchanger. Evaporation can favour the transfer of heat from the coolant via the heat exchanger to the air flow.

According to an advantageous embodiment, the fan can be designed as an axial fan, which has a fan wheel that can rotate about an axis of rotation of the fan with a hub and with several blades projecting from the hub at right angles to the axial direction. The axial direction is defined by the axis of rotation. The axial direction runs parallel to the axis of rotation. The pressure side and the suction side are then located axially on either side of the impeller or the blades. With the aid of such an axial fan, the air flow can be applied relatively homogeneously to a comparatively large area of the heat exchanger. The circular diameter of the axial fan in the area of the blades can be maximised with regard to the rectangular area of the heat exchanger in order to achieve maximum flow against and through the heat exchanger.

In principle, the exhaust gas line can be connected radially or tangentially to the axial fan and end radially at an outer circumference, for example. However, a configuration in which the exhaust gas line ends in the region of the hub is preferable. It has been shown that feeding the exhaust gas to the axial fan in the region of the hub results in significantly better mixing with the air flow than, for example, a radial feed. Accordingly, the exhaust gas can be diluted significantly better when fed in the region of the hub.

Another particularly advantageous embodiment is one in which the exhaust gas line is configured in such a way that it guides the exhaust gas axially to the hub. In order to reach the blades, the exhaust gas must first flow around the hub, whereby it is already distributed over a ring area that surrounds the hub and in which the blades rotate. This also supports the mixing and dilution of the exhaust gas in the air flow.

According to an advantageous embodiment, the exhaust gas line can have a distributor chamber at its outlet end, from which several distributor lines extend transversely to the axial direction, each of which opens out in the region of the blades. This means that the exhaust gas is initially fed centrally, in particular coaxially to the axis of rotation, to the distributor chamber and then distributed into the ring area of the rotating blades via the distributor lines, which in particular extend from the distributor chamber in a star shape with respect to the axis of rotation. There, the exhaust gas then exits via corresponding openings in the distributor lines on the suction side to the blades. This enables particularly intensive mixing and thus a reduction in the hydrogen content.

In another embodiment, the hub can contain a central hub channel that is axially open to the interior of the housing or to the exhaust gas line. The exhaust gas line can now open out in the region of the hub, in particular axially, so that the exhaust gas can flow from the exhaust gas line into the hub channel. At least one of the blades can now contain at least one blade channel in its interior, which is radially open to the hub channel. This allows the exhaust gas to flow from the hub duct into the respective blade duct. The respective blade channel can now be fluidically connected to at least one outlet opening, which is formed on the respective blade and which is open in the ring area in which the blades rotate. In other words, the respective outlet opening is open on the pressure side or on the suction side to the environment of the respective rotor blade. This means that the exhaust gas ultimately passes directly through the blade to the pressure side or suction side, where it can mix intensively with the air flow. During operation of the fan, the rotation of the blades due to the inertia causes the exhaust gas in the respective blade channel to be driven radially outwards, which draws the exhaust gas from the hub channel and creates a negative pressure there, which in turn draws the exhaust gas from the exhaust gas line.

A further embodiment proposes that an additional fan is arranged between the fan and the exhaust gas line and is designed as a radial fan and has an impeller that feeds exhaust gas supplied axially by the exhaust gas line radially to the area of the blades, i.e. the ring area. In this embodiment, the additional fan is used to distribute the exhaust gas fed axially and concentrically to the axial fan radially to the area of the impeller blades. This also supports intensive mixing with the air flow.

A first variant suggests that the impeller is connected to the hub for conjoint rotation, so that when the hub is rotating, the impeller draws in the exhaust gas supplied by the exhaust gas line axially and drives it radially into the area of the impeller blades. The rotating hub of the axial fan drives the impeller of the auxiliary fan, which is connected to it for conjoint rotation, in order to achieve the desired axial intake and radial distribution of the exhaust gas.

According to a second variant, the impeller can be arranged rotatably at an outlet end of the exhaust gas line and/or on the hub so that the exhaust gas supplied by the exhaust gas line drives the impeller in rotation, wherein the impeller deflects the incoming exhaust gas radially and feeds it to the area of the impeller blades. In this case, the impeller is driven by the flow of the exhaust gas and therefore rotates independently of the axial fan. This design also results in the advantageous distribution of the axially supplied exhaust gas over the annular surface in which the impeller blades rotate, mixing the exhaust gas with the air flow.

A preferred embodiment is one in which the respective fuel cell has a polymer electrolyte membrane that separates an anode side from a cathode side in the fuel cell.

A particularly advantageous embodiment is one in which the fuel cell system has a water tank for condensing, separating and collecting water carried in the anode exhaust gas and cathode exhaust gas. The water tank is connected on the inlet side to an anode outlet of the fuel cell stack carrying anode exhaust gas and to a cathode outlet of the fuel cell stack carrying cathode exhaust gas. Furthermore, the water tank is connected to the exhaust gas line on the outlet side, so that the exhaust gas line leads the exhaust gas formed by a mixture of anode exhaust gas and cathode exhaust gas from the water tank to the fan. Designs are also possible in which a common supply line is used to feed anode exhaust gas and cathode exhaust gas to the water tank. The water tank therefore has a dual function. On the one hand, it serves to condense, separate and collect the water carried in the exhaust gas. On the other hand, it ensures that the anode exhaust gas is mixed with the cathode exhaust gas. In this way, the concentration of hydrogen in the exhaust gas is already significantly reduced compared to the concentration prevailing in the anode exhaust gas.

A particularly expedient embodiment is one in which the heat exchanger has a condensate discharge structure coupled to the water tank, which is configured in such a way that it feeds condensate produced at the heat exchanger to the water tank. In addition to liquid water, the anode exhaust gas can also carry vapour water, which can also be contained in the mixture of anode exhaust gas and cathode exhaust gas discharged from the water tank. Water vapour can also be contained in the air flow. In any case, liquid water can condense and accumulate on the structure of the heat exchanger for various reasons. The condensate drain structure then ensures that the liquid water is ultimately fed into the water tank.

According to another advantageous embodiment, the heat exchanger can be arranged in or on one of the housing sides. This means that the air flow enriched with the exhaust gas exits at this side of the housing into the environment of the housing.

The heat exchanger can have a flat structure. The housing can form a cuboid and have flat housing sides. Expediently, the flat heat exchanger is aligned parallel to the associated flat housing side on or in which it is arranged.

The fuel cell system can optionally be equipped with a compressor for compressing fresh air drawn in from the environment into charge air. Furthermore, the fuel cell system can be equipped with a charge air cooler for cooling the charge air, which in particular is integrated into the cooling circuit into which the heat exchanger is also integrated.

Additionally or alternatively, the fuel cell system can be equipped with a humidifier for humidifying the fresh air or charge air, which can be used in particular to dehumidify the cathode exhaust gas at the same time. In particular, the humidity of the cathode exhaust gas is transferred to the fresh air or charge air in the humidifier.

In another embodiment, the fan can have an air guide structure that guides the air flow from the pressure side to the heat exchanger. For example, the air guide structure can form a bonnet covering the heat exchanger on one inflow side. Furthermore, the air guide structure can form an annular body in which the axial fan is arranged.

The housing or housing walls, which form the housing sides, are configured to be at least partially permeable to air. For this purpose, the housing walls can be equipped with openings, in particular in the form of perforations.

In another embodiment, a flame arrestor device can be arranged on or in an end portion of the exhaust gas line facing the fan to prevent the spread of a flame within the exhaust gas line. In the case of external ignition or fire sources in the vicinity of the fuel cell system, a flame can reach the exhaust gas line through the heat exchanger and also through the fan, at the outlet of which the exhaust gas can form an ignitable mixture depending on the operating state of the fuel cell. If ignition occurs, the flame arrestor prevents the flame triggered by the ignition from spreading inside the exhaust gas line so that the exhaust gas does not ignite inside the exhaust gas line. Such a flame arrester can be formed by any flame arrester or flame arrester suitable for hydrogen gas applications. Flame arresters are specified in more detail in the European standard EN ISO 16852:2016, for example.

Additionally or alternatively, a particle filter for filtering the exhaust gas can be arranged on or in an end portion of the exhaust gas line facing the fan. The particle filter can be used to filter particulate impurities carried in the exhaust gas, such as soot particles, out of the exhaust gas in order to prevent contamination and damage to the fan and the heat exchanger.

An electric vehicle according to the invention has an electric motor drive and a fuel cell system of the type described above. The fuel cell system is used to generate electrical energy to supply the electric drive. For this purpose, the fuel cell system is coupled to the drive and usually by an additional traction battery in a hybrid system to transmit electrical energy. The electric vehicle can be configured as an intralogistics vehicle and/or as a self-propelled vehicle.

Further important features and advantages of the invention can be found in the dependent claims, the drawings and the associated figure description with reference to the drawings.

It is understood that the features mentioned above and those to be explained below are usable not only in the combination indicated in each case, but also in other combinations or in isolation, without departing from the scope of the invention as defined by the claims. Components of a superordinate unit, such as a device, an apparatus or an arrangement, mentioned above and to be mentioned below, which are designated separately, can form separate parts or components of this unit or can be integral regions or portions of this unit, even if this is shown differently in the drawings.

Preferred embodiments of the invention are shown in the drawings and are explained in greater detail in the following description, with like reference signs referring to like or similar or functionally like components.

### BRIEF DESCRIPTION OF THE DRAWINGS

The drawings show, in each case schematically:

FIG. 1 shows a highly simplified isometric view of a fuel cell system;

FIG. 2 shows an isometric, partially sectional view of the fuel cell system in the area of a fan; and

FIGS. 3 to 6 shows views as in FIG. 2, but in other embodiments.

### DETAILED DESCRIPTION OF THE INVENTION

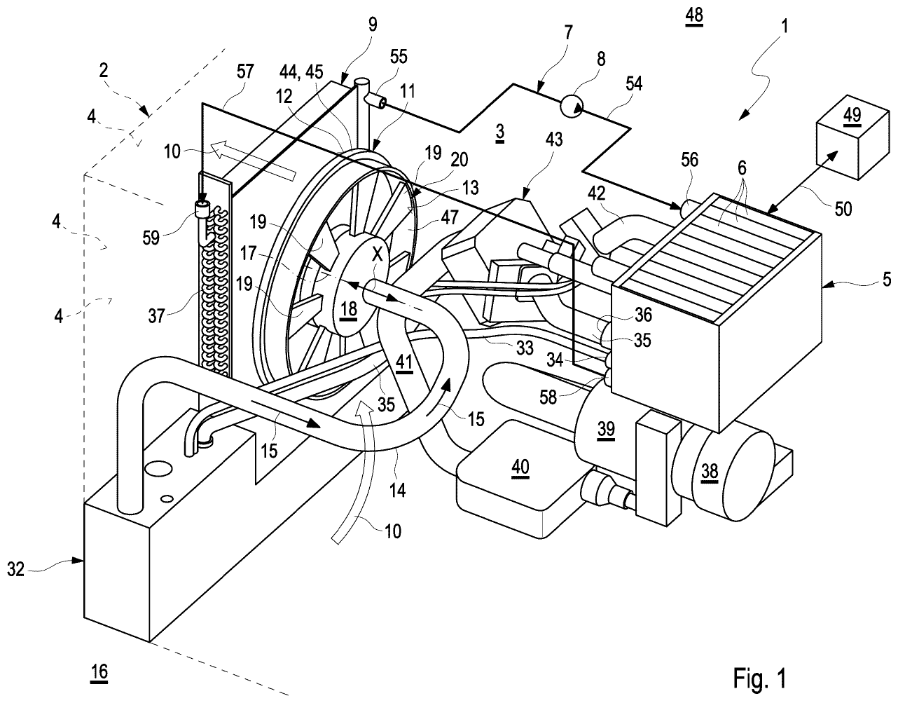

According to FIG. 1, a fuel cell system 1 comprises a housing 2, which is only indicated here by a broken line. The housing 2 encloses a housing interior 3 and has housing sides 4 that delimit the housing interior 3. The housing sides 4 can be formed by housing walls, which can be designed to be air-permeable with the aid of openings and/or perforations.

The fuel cell system 1 also has at least one fuel cell stack 5, which is arranged in the housing interior 3 and is formed with the aid of several fuel cells 6, which are stacked on top of each other for this purpose. Furthermore, the fuel cell system 1 is equipped with a cooling circuit 7, which is shown in simplified form in FIG. 1. The cooling circuit 7 is used to cool the fuel cell stack 5. A liquid coolant circulates in the cooling circuit 7 for this purpose. To drive the coolant, the cooling circuit 7 can have a coolant pump 8 in the usual manner. A heat exchanger 9 is integrated into the cooling circuit 7, which is used to cool the coolant. For this purpose, an air flow 10 can flow through the heat exchanger 9, which is indicated by arrows in FIG. 1. The cooling circuit 7 has a supply line 54, which connects a coolant outlet 55 of the heat exchanger 9 to a coolant inlet 56 of the fuel cell stack 5, and a return line 57, which connects a coolant outlet 58 of the fuel cell stack 5 to a coolant inlet 59 of the heat exchanger 9. The coolant pump 8 is preferably arranged in the supply line 54.

A fan 11 for driving the air flow 10 is also arranged in the housing interior 3, which has a pressure side 12 and a suction side 13. In FIGS. 1 to 6, the pressure side 12 faces away from the viewer, while the suction side 13 faces the viewer.

The fuel cell system 1 also has an exhaust gas line 14, which feeds exhaust gas 15, which is indicated by arrows in FIGS. 1 to 6 and ultimately comes from the fuel cells 6, to the suction side 13 of the fan 11. This exhaust gas line 14 can be designed as a hose or pipe.

During operation of the fan 11, the fan 11 generates the air flow 10, which flows from an environment 16 of the housing 2 into the housing interior 3 and flows through the heat exchanger 9 in the housing interior 3, thereby absorbing heat from the coolant, and then flows back out of the housing interior 3 into the environment 16. In order to avoid a short-circuit flow here, it is clear that an air inlet area on the housing 2, through which the air flow 10 enters the housing 2, is separated from an air outlet area, through which the air flow 10 exits the housing 2.

During operation of the fuel cell system 1, the exhaust gas 15 from the fuel cells 6 or the fuel cell stack 5 is fed to the suction side 13 of the fan 11 via the exhaust gas line 14, which automatically results in mixing between the exhaust gas 15 and the air flow 10, which significantly reduces any concentration of hydrogen contained in the exhaust gas 15.

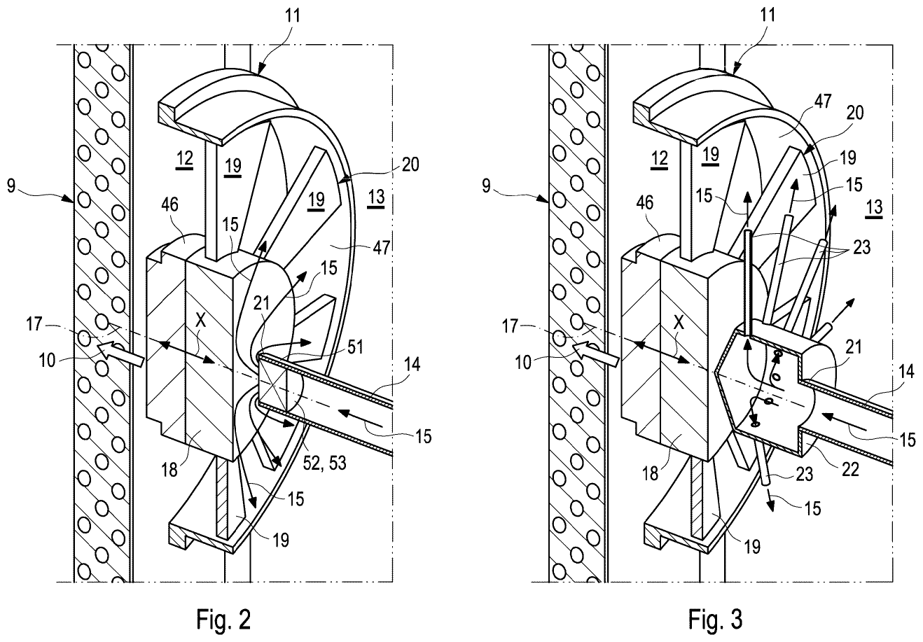

The preferred embodiment is the one shown here, in which the fan 11 is located upstream of the heat exchanger 9 with respect to the air flow 10. As a result, the suction side 13 faces the interior of the housing 3, while the pressure side 12 faces the heat exchanger 9. Furthermore, it is preferable that the fan 11 is configured as an axial fan, so that the fan 11 has an axis of rotation 17 and a hub 18 that can rotate about the axis of rotation 17, from which several blades 19 protrude transversely to the axial direction X. The axial direction X extends parallel to the axis of rotation 17. The hub 18 forms a fan wheel 20 with the blades 19, which can be rotated about the axis of rotation 17. The fan 11 can be driven by an electric motor. In particular, a corresponding electric motor 46 can be arranged in or on the hub 18 and is recognisable in the sectional views of FIGS. 2 to 6. Conveniently, the exhaust gas line 14 is arranged such that it ends in the region of the hub 18, wherein the exhaust gas line 14 can in particular be configured such that it feeds the exhaust gas 15 to the hub 18 axially and/or concentrically to the axis of rotation 17.

In a particularly simple embodiment, which is shown in FIG. 2, the exhaust gas line 14 ends at an axial distance from the hub 18 and is aligned coaxially and axially to the axis of rotation 17. The exhaust gas 15 passes over or along the hub 18 into a ring area 47 in which the blades 19 rotate. In the axial fan, this ring area 47 is arranged in a ring around the hub 18. In this ring area 47, the exhaust gas 15 is swirled and mixed with the air flow 10 by the rotation of the blades 19. One outlet end 21 of the exhaust gas line 14 is at an axial distance from the hub 18.

In the embodiment shown in FIG. 3, the exhaust gas line 14 has a distributor chamber 22 at its outlet end 21, from which several distributor lines 23 branch off transversely to the axial direction X. These distributor lines 23 each open in the area of the blades 19. For example, the distributor lines 23 each have a radially open end. The exhaust gas 15 flows through the exhaust gas line 14 to the distributor chamber 22 and is distributed therein to the distributor lines 23. The exhaust gas 15 then flows through the distributor lines 23 and exits at their openings, in particular at their ends in the ring area 47 of the blades 19, and thus reaches the suction side 13 of the fan 11.

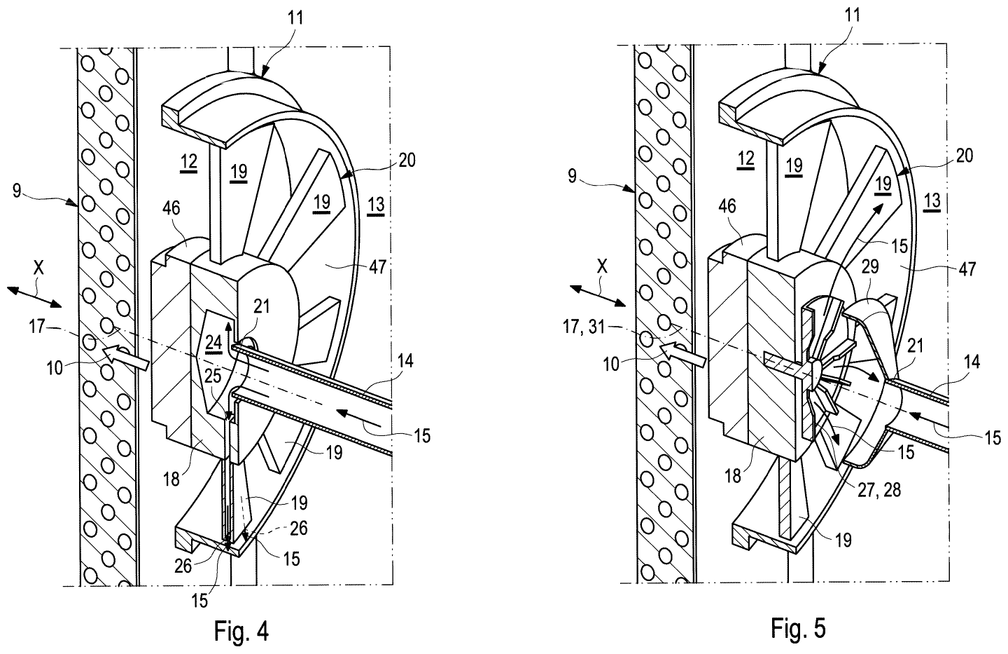

In the embodiment shown in FIG. 4, the hub 18 has a central hub channel 24, which is open axially towards the exhaust gas line 14. The exhaust gas line 14 opens in the area of the hub 18, preferably axially. Conveniently, the exhaust gas line 14 opens in the area of the open end of the hub channel 24. In the example of FIG. 4, the exhaust gas line 14 extends with its outlet end 21 axially into the hub channel 24. In particular, the exhaust gas line 14 has sufficient radial clearance and/or axial clearance from the hub 18 at its outlet end 21. At least one of the blades 19 contains at least one blade channel 25 in its interior, which is radially open to the hub channel 24. The rotor blade 19 equipped with the respective blade channel 25 has at least one outlet opening 26, which is fluidically connected to the respective blade channel 25. The respective outlet opening 26 is located on or in the annular region 47 on an outer side of the respective rotor blade 19. The respective outlet opening 26 is thus located on the pressure side 12 or on the suction side 13 or between the pressure side 12 and the suction side 13 and is open to the environment of the respective rotor blade 19. This allows the exhaust gas 15 to flow through the exhaust gas line 14 to the hub channel 24. The exhaust gas 15 then continues to flow from the hub duct 24 through the blade ducts 25 to the outlet openings 26 and from the outlet openings 26 into the ring area 47, in which the blades 19 rotate. In the example of FIG. 4, the outlet openings 26 are formed purely by way of example at the radial end of the respective rotor blade 19, so that the outlet openings are radial. In addition or alternatively, several or all outlet openings 26 can also be arranged on an axial outer side of the respective rotor blade 19, so that they face directly towards the pressure side 12 or the suction side 13. An outlet on the suction side is preferred, as it supports the flow of the exhaust gas 15 due to the negative pressure.

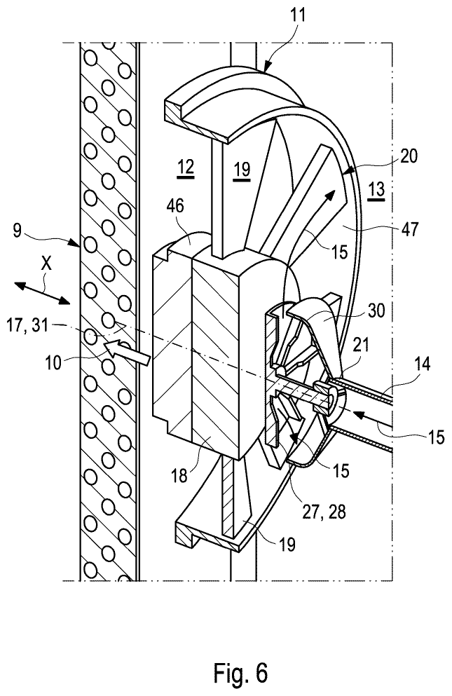

In the embodiments shown in FIGS. 5 and 6, an additional fan 27 is arranged between the fan 11 and the exhaust gas line 14. This additional fan 27 is appropriately designed as a radial fan and has an impeller 28, which feeds exhaust gas 15 supplied axially from the exhaust gas line 14 radially to the ring area 47 of the blades 19.

In the example in FIG. 5, the impeller 28 is connected to the hub 18 in a rotationally fixed manner. When the hub 18 rotates, i.e. during operation of the fan 11, the impeller 28 also rotates and thus draws in the exhaust gas 15 at the outlet end 21 of the exhaust gas line 14 and feeds it radially to the ring area 47 of the blades 19. In the example in FIG. 5, the exhaust gas line 14 is preferably without contact to the impeller 28. A distributor structure 29 can be formed at the outlet end 21, which improves the inflow to the impeller 28. The distributor structure 29 is designed here as a diffuser or funnel that widens in the direction of flow of the exhaust gas 15.

In the example shown in FIG. 6, the impeller 28 is rotatably arranged at the outlet end 21 of the exhaust gas line 14. For this purpose, the outlet end 21 can have a bearing structure 30 for rotatably mounting the impeller 28. In the embodiment shown in FIG. 6, the exhaust gas 15 supplied by the exhaust gas line 14 drives the impeller 28 in rotation. In this case, the impeller 28 deflects the axially arriving exhaust gas 15 radially and guides it to the ring area 47 in which the impeller blades 19 rotate. It may also be useful here to ensure that there is no contact between the exhaust gas line 14 and the fan 11. In particular, the impeller 28 can be axially spaced from the hub 18.

Alternatively, in another embodiment, a configuration is also conceivable in which the impeller 28 is rotatably mounted on the hub 18. The bearing of the impeller 28 on the hub 18 can be provided in addition to or as an alternative to the bearing of the impeller 28 on the exhaust gas line 14. In this case, the axis of rotation 17 of the fan 11 and an axis of rotation 31 of the impeller 28 coincide.

The respective fuel cell 6 can have a polymer electrolyte membrane, which is not shown in detail here. The membrane separates an anode side from a cathode side within the respective fuel cell 6.

According to FIG. 1, the fuel cell system 1 can have a water tank 32, which is used to collect water that is carried in the anode exhaust gas. An anode exhaust gas line 33 feeds anode exhaust gas from an anode outlet 34 of the fuel cell stack 5 to the water tank 32. A cathode exhaust gas line 35 connects a cathode outlet 36 of the fuel cell stack 5 to the water tank 32. The anode exhaust gas line 33 feeds anode exhaust gas and gaseous and liquid water carried therein to the water tank 32. The liquid water is collected in the water tank 32. Gaseous water can at least partially condense in the water tank 32 and thus also remains in the water tank 32. The cathode exhaust gas line 35 feeds cathode exhaust gas to the water tank 32 where it mixes with the anode exhaust gas, simultaneously diluting the anode exhaust gas. A mixture of anode exhaust gas and cathode exhaust gas is produced in the water tank 32, which then forms the exhaust gas 15 of the fuel cells 6 or the fuel cell stack 5, which is discharged from the water tank 32 using the exhaust gas line 14 and fed to the fan 11.

The heat exchanger 9 can be equipped with a condensate drain structure 37, which is fluidically coupled to the water tank 32 in a suitable manner and which is configured in such a way that it feeds condensate that accumulates at the heat exchanger 9 to the water tank 32. Water vapour contained in the exhaust gas 15 can condense as it flows through the heat exchanger 9 and thus enter the water tank 32 via the condensate drain structure 37.

In the embodiments shown here, the heat exchanger 9 is conveniently arranged on or installed in one of the housing sides 4. The heat exchanger 9 can be configured to be flat and aligned parallel to the likewise flat housing side 4.

According to FIG. 1, the fuel cell system 1 can also be equipped with a compressor 38 for compressing fresh air drawn in from the environment 16 into charge air. An air filter 39 can be conveniently connected upstream of the compressor 38. During compression, the air heats up so that warm charge air is discharged from the compressor 38. A charge air cooler 40 can be provided to help cool the charge air. The charge air cooler 40 can be conveniently integrated into the cooling circuit 7. However, corresponding coolant lines are not shown here. The cooled charge air can then be fed from the charge air cooler 40 to the fuel cell stack 5 via a cathode fresh gas line 41. In the example shown in FIG. 1, a humidifier 43 is arranged between the charge air cooler 40 and a cathode inlet 42 of the fuel cell stack 5. This humidifier 43 is also integrated into the cathode exhaust gas line 35 in such a way that moisture contained in the cathode exhaust gas is transferred to the fresh air or charge air in the humidifier 43. In this way, the fresh air is humidified on the one hand, while the anode exhaust gas is dehumidified or dried on the other.

For an efficient flow through the heat exchanger 9, an air guide structure 44 can also be provided, which is only partially shown here and which has at least one annular body 45 recognisable in FIG. 1, which surrounds the ring area 47, in which the blades 19 rotate, in an annular and radial manner. The air guide structure 44 can also form or have a bonnet, not shown here, which forms an air-conducting duct-shaped transition between the circular annular body 45 and the generally rectangular heat exchanger 9. The air guide structure 44 connects the fan 11 with respect to the air flow 10 with an inflow side of the heat exchanger 9. As a result, the exhaust gas 15 can no longer escape as soon as it reaches the suction side 13 of the fan 11, so that it must inevitably mix with the air flow 10 and is blown out with it through the heat exchanger 9 into the environment 16.

According to FIG. 2, a flame arrester 52 for preventing the spread of a flame within the exhaust gas line 14 and/or a particle filter 53 for filtering the exhaust gas 15 can be arranged on or in an end portion 51 of the exhaust gas line 14 facing the fan 11, at which the outlet end 21 is located. The flame arrester 52 is impermeable to a flame coming from the environment 16, so that ignition cannot spread through the exhaust gas line 14 to the water tank 32. The exhaust gas 15 flows through the particle filter 53 and retains particles that are transported in the exhaust gas 15. The flame arrester 52 and the particle filter 53 can be combined as shown to form a combined flame arrester-filter device. It is also conceivable to provide the flame arrester 52 and the particle filter 53 as separate components, with the particle filter 53 being arranged upstream of the flame arrester 52 with respect to the direction of flow of the exhaust gas 15. Although the flame arrester 52 and the particle filter 53 have only been introduced here with reference to FIG. 2, it is clear that the flame arrester 52 and/or the particle filter 53 can also be realised in a corresponding manner in all other embodiments.

According to FIG. 1, the fuel cell system 1 can form a component of an electric vehicle 48, not otherwise shown, which has an electric motor drive 49 that is coupled to the fuel cell system 1 in a suitable manner for transmitting 50 electrical energy. The fuel cell system 1 is used to generate electrical energy, which is used to supply the electric drive 49.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A fuel cell system (1) comprising:
a housing (2) which encloses an inner housing space (3) and has housing sides (4) which delimit the inner housing space (3) and are at least partially air-permeable,
with at least one fuel cell stack (5) arranged in the housing interior (3), which has a plurality of fuel cells (6),
with a cooling circuit (7) for cooling the fuel cell stack (5), in which a liquid coolant circulates,
with a heat exchanger (9), which is integrated into the cooling circuit (7) for cooling the coolant and through which an air flow (10) can flow,
with a fan (11), which is arranged in the housing interior (3) for driving the air flow (10) and which has a pressure side (12) and a suction side (13),
with an exhaust gas line (14) that feeds exhaust gas (15) from the fuel cells (6) to the suction side (13) of the fan (11),
wherein the air flow (10) flows during operation of the fan (11) from an environment (16) of the housing (2) into the housing interior (3) and flows in the housing interior (3) through the heat exchanger (9) and from the housing interior (3) back into the environment (16).

2. The fuel cell system (1) according to claim 1,
wherein
the fan (11) is arranged upstream of the heat exchanger (9) with respect to the air flow (10), so that the suction side (13) faces the housing interior (3), while the pressure side (12) faces the heat exchanger (9).

3. The fuel cell system (1) according to claim 1,
wherein
the fan (11) is designed as an axial fan which has a hub (18) rotatable about an axis of rotation (17) of the fan (11) and a plurality of blades (19) projecting from the hub (18) transversely to the axial direction (X).

4. The fuel cell system (1) according to claim 3,
wherein
the exhaust gas line (14) ends in the region of the hub (18).

5. The fuel cell system (1) according to claim 4,
wherein
the exhaust gas line (14) guides the exhaust gas (15) axially to the hub (18).

6. The fuel cell system (1) according to claim 1,
wherein
the exhaust gas line (14) has a distributor chamber (22) at its outlet end (21), from which a plurality of distributor pipes (23) extend transversely to the axial direction (X), each of which opens in the region of the rotor blades (19).

7. The fuel cell system (1) according to claim 1,
wherein
the hub (18) contains a central hub channel (24) which is axially open to the exhaust gas line (14) and/or to the housing interior (3),
the exhaust gas line (14) opens in the area of the hub (18),
at least one of the rotor blades (19) contains at least one blade channel (25) which is radially open towards the hub channel (24),
the respective blade channel (25) is fluidically connected to at least one outlet opening (26), which is formed on the respective blade (19) and which is open to the environment of the respective blade (19).

8. The fuel cell system (1) according to claim 1,
wherein
an additional fan (27) is arranged between the fan (11) and the exhaust gas line (14) and is designed as a radial fan and has an impeller (28) that feeds exhaust gas (15) supplied axially by the exhaust gas line (14) radially to the region of the impeller blades (19).

9. The fuel cell system (1) according to claim 8,
wherein
the impeller (28) is connected to the hub (18) in a rotationally fixed manner, so that the impeller (28) sucks in the exhaust gas (15) supplied by the exhaust gas line (14) axially and drives it radially into the region of the impeller blades (19) when the hub (18) is rotating.

10. The fuel cell system (1) according to claim 8,
wherein
the impeller (28) is rotatably arranged at an outlet end (21) of the exhaust gas line (14) and/or at the hub (18), so that the exhaust gas (15) supplied by the exhaust gas line (14) drives the impeller (28) in rotation, the impeller (28) deflecting the incoming exhaust gas (15) radially and supplying it to the region of the impeller blades (19).

11. The fuel cell system (1) according to claim 1,
wherein
the respective fuel cell (6) has a polymer electrolyte membrane which separates an anode side from a cathode side in the fuel cell (6).

12. The fuel cell system (1) according to claim 1,
wherein
the fuel cell system (1) has a water tank (32) for collecting water carried in anode exhaust gas, which is connected on the input side to an anode outlet (34) of the fuel cell stack (5) carrying anode exhaust gas and to a cathode outlet (35) of the fuel cell stack (5) carrying cathode exhaust gas, and which is connected on the output side to the exhaust gas line (14), so that the exhaust gas line (14) leads the exhaust gas (15) formed by a mixture of anode exhaust gas and cathode exhaust gas from the water tank (32) to the fan (11).

13. The fuel cell system (1) according to claim 12,
wherein
the heat exchanger (9) has a condensate drainage structure (37) coupled to the water tank (32), which feeds condensate produced at the heat exchanger (9) to the water tank (32).

14. The fuel cell system (1) according to claim 1,
wherein
the heat exchanger (9) is arranged in or on one of the housing sides (4).

15. The fuel cell system (1) according to claim 1,
wherein
a flame arrestor device ( ) for preventing the spread of a flame within the exhaust gas line (14) and/or a particle filter ( ) for filtering the exhaust gas (15) is arranged on or in an end portion ( ) of the exhaust gas line (14) facing the fan (11).

16. An electric vehicle (48),
with an electric motor drive (49),
with the fuel cell system (1) according to claim 1 for generating electrical energy for supplying the electric drive (49),
wherein the fuel cell system (1) is coupled to the drive (49) for the transmission (50) of electrical energy.
